(19) United States
(12) Patent Application Publication
(10) Pub. No.: US 2011/0206933 A1
(43) Pub. Date: Aug. 25, 2011

(54) Electrically Insulating Thermally Conductive Polymer Composition

(75) Inventors: Sung-Jun KIM, Anyang-si (KR); Chang-Min HONG, Uiwang-si (KR)

(73) Assignee: CHEIL INDUSTRIES INC., Gumi-si (KR)

(21) Appl. No.: 13/100,443

(22) Filed: May 4, 2011

Related U.S. Application Data
(63) Continuation-in-part of application No. PCT/KR2008/007778, filed on Dec. 30, 2008.

(30) Foreign Application Priority Data
Nov. 5, 2008 (KR) 10-2008-0109454

(51) Int. Cl. C09K 5/08; C08K 3/08

(52) U.S. Cl. 428/401; 252/75

(57) ABSTRACT

An electrically insulating highly thermally conductive resin composition includes (A) 100 parts by weight of a polyamide-based resin, and (B) 10 to 80 parts by weight of a long metal fiber including a metal comprising copper, nickel, aluminum, iron, chromium, molybdenum, an alloys thereof, or a combination thereof. The electrically insulating highly thermally conductive resin composition can exhibit high hardness and high strength as well as excellent electrically insulating and thermal conductivity properties, and can be useful for various molded products requiring high thermal conductivity and excellent mechanical characteristics.

### CROSS-REFERENCE TO RELATED APPLICATIONS

This application is a continuation-in-part of International Application No. PCT/KR2008/007778, filed on Dec. 30, 2008, pending, which designates the U.S., published as WO 2010/053225, and is incorporated herein by reference in its entirety, and claims priority therefrom under 35 USC Section 120. This application also claims priority under 35 USC Section 119 to and the benefit of Korean Patent Application No. 10-2008-0109454 filed in the Korean Intellectual Property Office on Nov. 5, 2008, the entire disclosure of which is also incorporated herein by reference.

### FIELD OF THE INVENTION

The present invention relates to an electrically insulating highly thermally conductive resin composition

### BACKGROUND OF THE INVENTION

Thermally conductive materials are increasingly used due to increased power consumption of many electronic parts and devices. Conventional thermally conductive materials are primarily formed of a metal. Thermally conductive metal materials, however, can have poor formability and productivity and further can be limited with respect to complex part design. Therefore, efforts have focused on the development of thermally conductive materials with improved formability and productivity that can be used as a substitute for thermally conductive metal materials.

Thermally conductive polymer resin materials, which include a polymer and a thermally conductive filler, have been used with some success as a substitute for thermally conductive metal materials. Thermally conductive polymer resin materials can improve productivity and can allow the production of complex shaped partsusing injection molding methods. Generally polymer materials have a thermal conductivity of 0.1 to 0.4 [W/mK], which is a thermal insulator value. Adding thermally conductive fillers to a polymer can increase thermal conductivity up to 10 [W/mK]. Adding thermally conductive fillers to a polymer can, however, significantly increase viscosity and decrease mechanical properties, which can minimize the benefits of using a thermally conductive polymer resin material. Further, metal may still be needed for parts requiring higher thermal conductivity.

Recently, in order to provide an appropriate level of physical properties and sufficient fluidity for injection molding, there has been a focus on adding a minimum amount of thermally conductive fillers to a polymer. The resultant thermally conductive polymer resin materials, however, can still exhibit reduced mechanical strength as compared to that of a general enforced resin composite material.

Thermally conductive polymer resin materials may be generally classified as electrically conductive orelectrically insulative materials. The type of thermally conductive polymer resin material used in a particular application can depend on the required properties of the product. For example, semi-conductor or electric/electronic parts that heat up and in which electrical interference should be minimized or eliminated should include a thermally conductive resin with electrical insulating properties. Many materials used as conductive fillers in thermally conductive polymer resin materials, however, such as metal or graphite fillers, are electrical conductors, and accordingly thermally conductive polymer resin materials including the same also can have electrical conductivity.

Alternatively, thermally conductive polymer resin materials can include electrically insulating fillers. Examples of electrically insulating fillers include ceramic fillers, such as BN, AlN, SiC, and the like.

Ceramic fillers, however, can impart inferior thermal conductivity to a polymer material as compared to metal or graphite fillers. Further, ceramic fillers can be significantly more expensive than metal or graphite fillers. In addition, the resultant polymer resin material including ceramic fillers can exhibit poor physical properties. Nonetheless, there are no alternatives for ceramic filler to date, and accordingly polymer/ceramic filler composites are currently used in the development of electrically insulating thermally conductive resins in spite of such drawbacks.

Japanese Patent Laid-Open Publication No. 2006-22130 is directed to a thermally conductive polymer composite material including a crystalline resin, a low-melting point metal alloy, metal or alloy powder compatible with the low-melting point metal alloy for increasing the dispersability of the metal alloy in the crystalline polymer, an inorganic powder having poor compatibility with the low-melting point metal alloy, and a fibrous reinforcing material, such as glass fiber. However, because the primary thermal conductors include a low-melting point metal alloy and an inorganic powder that is incompatible with the metal alloy, contact efficiency between the thermally conductive fillers is decreased. Further, the crystalline polymer includes a large amount of materials that are incompatible with each other, which can deteriorate the physical properties of the composite material.

Japanese Patent Laid-Open Publication No. 2005-074116 discloses a thermally conductive polymer composite including expanded graphite and general, non-expanded graphite in a ratio of 1/9 to 5/5. However, the polymer composite can have high viscosity and also be fragile. Also, the composite material can cause “slurping” in which the graphite is smeared on a surface of a material.

U.S. Pat. No. 6,048,919 to McCullough is directed to a thermally conductive composition including 30 to 60 volume percent polymer base matrix, 25 to 60 volume percent of a first thermally conductive filler having an aspect ratio of at least 10:1 and 10 to 25 volume percent of a second thermally conductive filler having an aspect ratio of 5:1 or less. However, this composition can also exhibit low possibility of contact between thermally conductive fillers.

U.S. Pat. No. 5,011,872 to Latham et al. is directed to a thermally conductive polymer composition including a polymer and a thermally conductive filler material with a medium particle size of 130 to 260 μm. The filler can be a ceramic filler material such as BN, SiC, and AlN. U.S. Pat. No. 5,232,970 to Solc et al. is directed to a thermally-conductive composite including a polyamide or a polybenzocyclobutene and at least 35 volume % of a ceramic filler. The polyamide composite can further include silica. U.S. Pat. No. 6,822,018 the Chaudhuri et al. is directed to a thermally-conductive electrically insulating polymer-based material including metal particles dispersed in an epoxy, silicone, or polyurethane matrix material. The metal particles are encapsulated with a dielectric coating. The polymer-based material can further include dielectric particles formed of a ceramic material dispersed in the matrix material. Accordingly, the electrically insulating thermally conductive resin composite materials of the foregoing patents include ceramic fillers.

### SUMMARY OF THE INVENTION

The present invention provides an electrically insulating highly thermally conductive resin composition. The electrically insulating highly thermally conductive resin composition can have excellent electrical insulation and thermal conductivity properties as well as excellent mechanical characteristics such as high hardness and high strength.

Yet another embodiment of the present invention provides a molded product obtained from the electrically insulating highly thermally conductive resin composition.

The embodiments of the present invention are not limited to the above technical purposes, and a person of ordinary skill in the art can understand other technical purposes.

According to one embodiment of the present invention, an electrically insulating highly thermally conductive resin composition is provided that includes (A) 100 parts by weight of a polyamide-based resin, and (B) 10 to 80 parts by weight of a long metal fiber including a metal comprising copper, nickel, aluminum, iron, chromium, molybdenum, alloys thereof, or a combination thereof.

The electrically insulating highly thermally conductive resin composition may include a low-melting point metal (C) in an amount of 0.5 to 10 parts by weight based on 100 parts by weight of the polyamide-based resin (A).

According to another embodiment of the present invention, a molded product fabricated using the electrically insulating highly thermally conductive resin composition is provided.

Hereinafter, further embodiments of the present invention will be described in detail.

The electrically insulating highly thermally conductive resin composition according to the present can exhibit high hardness and high strength as well as excellent electrical insulating and thermal conductivity properties. The composition of the invention can accordingly be used in various molded products requiring excellent mechanical characteristics as well as high thermal conductivity.

### DETAILED DESCRIPTION OF THE INVENTION

The present invention will be described more fully hereinafter in the following detailed description of the invention, in which some but not all embodiments of the invention are described. Indeed, this invention may be embodied in many different forms and should not be construed as limited to the embodiments set forth herein; rather, these embodiments are provided so that this disclosure will satisfy applicable legal requirements. Like numbers refer to like elements throughout the specification.

The electrically insulating highly thermally conductive resin composition according to one embodiment of the present invention includes (A) 100 parts by weight of a polyamide-based resin, and (B) 10 to 80 parts by weight of a long metal fiber including a metal comprising copper, nickel, aluminum, iron, chromium, molybdenum, an alloy thereof, or a combination thereof.

Exemplary components included in the electrically insulating highly thermally conductive resin composition according to embodiments of the present invention will hereinafter be described in detail.

(A) Polyamide-Based Resin

The polyamide-based resin is a resin including an amide (—NHCO—) group bound to a polymer main chain. Specific examples may include without limitation polycaproamide (nylon 6), polytetramethylene adipamide (nylon 46), polyhexamethylene adipamide (nylon 66), poly(hexamethylene nonanediamide) (nylon 69), poly(hexamethylene sebacamide) (nylon 610), poly(hexamethylenedodecanediamide), polyhexamethylene dodecanamide (nylon 612), nylon 611, nylon 1212, nylon 1012, polyundecanoamide (nylon 11), polydodecanamide (nylon 12), polyhexamethylene terephthalamide (nylon 6T), polyhexamethylene isophthalamide (nylon 6I), nylon 9T, nylon 10T, polyundecamethylene terephthalamide (nylon 11T), nylon 12T, nylon 12I, polyphthalamide (PPA), a polycaproamide/polyhexamethylene adipamide copolymer (nylon 6/66), a polyhexamethylene terephthalamide/polyhexamethylene isophthalamide copolymer (nylon 6T/61), a polyhexamethylene adipamide/polyhexamethylene terephthalamide copolymer (nylon 66/6T), poly-bis-(4-aminocyclohexyl)methanedodecamide (nylon PACM12), poly-bis-(3-methyl-4-aminocyclohexyl)methanedodecamide (nylon dimethyl PACM12), polymetaxylene adipamide (MXD 6), polyundeca methylene hexahydroterephthalamide (nylon 11T(H)), and the like, and combinations thereof.

Additional examples of the polyamide-based resin include a blend of a polyamide-based polymer resin with another resin. Examples of the blend include without limitation polyphthalamide (PPA)/polyphenylene ether (PPE), polyamide (PA)/polyphenylene sulfide (PPS), polyamide (PA)/acrylonitrile-butadiene-styrene (ABS), and the like.

Conventional polymer/metal composite materials can be electrically conductive. In contrast, the polyamide-based resin exhibits an electrical insulating property when it is used with a certain amount or less of a metal component due to the polar amide (—NHCO—) group, due to the phenomenon of trapping electrons. Accordingly, the polyamide-based resin can be very suitable for a resin composition requiring both electrical insulating and high thermal conductivity properties together with excellent formability.

According to one embodiment, the electrically insulating highly thermally conductive resin composition includes nylon 66 or PPA. PPA can have high thermal resistance and thus can be useful in applications requiring high thermal resistance used for electrical insulation/thermal conductivity, such as but not limited to a connector, a lamp socket, a lamp reflector, and the like, which are used in a lead-free soldering process.

(B) Long Metal Fiber

The long metal fiber plays a role of improving the hardness and the strength characteristics of the composition. As used herein, the term “long metal fiber” refers to a metal fiber having a length of 5 to 30 mm. In some embodiments, the long metal fiber can have a length of 5, 6, 7, 8, 9, 10, 11, 12, 13, 14, 15, 16, 17, 18, 19, 20, 21, 22, 23, 24, 25, 26, 27, 28, 29, or 30_mm. Further, according to some embodiments of the present invention, the length of the long metal fiber can be in a range from any of the foregoing lengths to any other of the foregoing lengths.

The long metal fiber can be in the form of a roving that includes a bundle of a plurality of long metal fibers having an average diameter of 1 to 65 μm and that is capable of being continuously immersed into a resin using a glass roving device.

Examples of the metal of the long metal fiber according to one embodiment of the present invention may include without limitation copper, nickel, aluminum, iron, chromium, molybdenum, alloys thereof, and the like, and combinations thereof. In exemplary embodiments, the long metal fiber includes aluminum. In other exemplary embodiments, the long metal fiber includes a metal alloy. Exemplary metal alloys include without limitation, copper/nickel/molybdenum alloys, stainless steel alloys such as nickel/chromium/iron alloys, and the like.

The electrically insulating highly thermally conductive resin composition includes the long metal fiber in an amount of 10 to 80 parts by weight, for example 50 to 75 parts by weight, based on 100 parts by weight of the polyamide-based resin. In some embodiments, the electrically insulating highly thermally conductive resin composition can include the long metal fiber in an amount of 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, or 80 parts by weight. Further, according to some embodiments of the present invention, the amount of the long metal fiber can be in a range from any of the foregoing amounts to about any other of the foregoing amounts.

When the electrically insulating highly thermally conductive resin composition includes the long metal fiber in an amount within these ranges, the composition can exhibit a balance of mechanical strength and impact strength.

(C) Low-Melting Point Metal

The electrically insulating highly thermally conductive resin composition according to the present invention may further include a low-melting point metal.

The low-melting point metal can help maximize contact between the long metal fibers. The low-melting point metal can include one kind of metal or can include a solid solution including two or more kinds of metals. In one embodiment, the low-melting point metal is a solid solution.

According to one embodiment, the low-melting point metal of the solid solution is a metal solid solution having a solidus temperature that is lower than the melting point of the (A) polyamide-based resin. When the solidus temperature is lower than the melting point of the polyamide-based resin, for example when the solidus temperature is 20° C. or more lower than the melting point of the polyamide-based resin, this can improve the stability during preparation of the electrically insulating highly thermally conductive resin composition. In exemplary embodiments, the solidus temperature can be at least 100° C. or more higher than the environment in which the composition is used.

The solid solution of low-melting point metal can include a first metal element comprising tin, bismuth, lead, or a combination thereof, and a second metal element comprising copper, aluminum, nickel, silver, germanium, indium, zinc, or a combination thereof.

For example, when the long metal fiber includes aluminum, the solid solution can also include aluminum as a component thereof; as another example, when the long metal fiber includes copper, the solid solution can also include copper as a component thereof. In other exemplary embodiments, the first metal element of the solid solution can be tin, which can be environmentally advantageous.

In addition, it is possible to control physical properties such as solidus temperature, liquidus temperature, mechanical strength, and the like of the low-melting point metal by adjusting the ratio of the amounts of the first metal element and the second metal element. According to one embodiment, the first metal element and the second metal element are included in a weight ratio of 99.5:0.5 to 89:11.

In some embodiments, the low-melting point metal can include the first metal element in an amount of 89, 90, 91, 92, 93, 94, 95, 96, 97, 98, 99, 99.1, 99.2, 99.3, 99.4, or 99.5 percent by weight. Further, according to some embodiments of the present invention, the amount of the first metal element can be in a range from any of the foregoing amounts to about any other of the foregoing amounts.

In some embodiments, the low-melting point metal can include the second metal element in an amount of 0.5, 0.6, 0.7, 0.8, 0.9, 1, 2, 3, 4, 5, 6, 7, 8, 9, 10, or 11 percent by weight. Further, according to some embodiments of the present invention, the amount of the second metal element can be in a range from any of the foregoing amounts to about any other of the foregoing amounts.

When first metal element and the second metal element are included in a weight ratio without this range, it is possible to provide a low-melting point metal with an optimal solidus temperature.

The electrically insulating highly thermally conductive resin composition can include the low-melting point metal in an amount of 0.5 to 10 parts by weight, for example 0.5 to 5 parts by weight, based on 100 parts by weight of polyamide-based resin. In some embodiments, the electrically insulating highly thermally conductive resin composition can include the low-melting point metal in an amount of 0.5, 0.6, 0.7, 0.8, 0.9, 1, 2, 3, 4, 5, 6, 7, 8, 9, or 10 parts by weight. Further, according to some embodiments of the present invention, the amount of the low-melting point metal can be in a range from any of the foregoing amounts to about any other of the foregoing amounts.

When the low-melting point metal is added in an amount within these ranges, it can be mixed well during the preparation of the resin composition, so as to improve the formation of a network and thermal conductivity.

(D) Other Additives

The electrically insulating highly thermally conductive resin compositions according to one embodiment of the present invention may further include one or more other additives such as glass fiber, glass beads, calcium carbonate (CaCO₃), and the like, and combinations thereof in order to maximize contact between the long metal fibers and/or improve the mechanical properties of the resin composition.

In addition, the electrically insulating highly thermally conductive resin composition may further include one or more other additives. Examples of other additives include without limitation antioxidants, weather resistance agents, flame retardants, release agents, lubricants, colorants, and the like, and combinations thereof.

Exemplary antioxidants may include without limitation phenol antioxidants, phosphite antioxidants, thioether antioxidants, amine antioxidants, and the like, and combinations thereof.

Exemplary weather-resistance agents may include without limitation benzophenone weather-resistance agents, amine weather-resistance agents, and the like, and combinations thereof.

The flame retardant is not specifically limited, and exemplary flame retardants may include without limitation halogen-based flame retardants, phosphorous flame retardants, metal salt-based flame retardants, silicone-based flame retardants, and the like, and combinations thereof.

Exemplary release agents may include without limitation fluorine-containing polymers, silicone oils, metal salts of stearic acid, metal salts of montanic acid, montanic acid ester waxes, polyethylene waxes, and the like, and combinations thereof.

Exemplary colorants may include without limitation dyes, pigments, and the like, and combinations thereof.

The electrically insulating highly thermally conductive resin composition may be prepared in accordance with general methods known in the art for preparing a resin composition. For example, the composition may be prepared by simultaneously mixing the constituting components and other additives, and melt-extruding the mixture in an extruder to provide a pellet shape. Alternatively, the mixture may be directly melt extruded to form a molded product.

When the constituting components are mixed, the long metal fiber may be charged by inputting it into the same inlet used for the other components of the mixture or into an inlet other than the outlet used for the other components of the mixture. According to one embodiment, a glass roving device can be used to continuously add a roving including a plurality of long metal strands or fibers to a melt of the polyamide-based resin and optionally the low-melting point metal.

The electrically insulating highly thermally conductive resin composition according to one embodiment of the present invention may be prepared by adding (charging) a long metal fiber to a mixture including the polyamide-based resin and optionally the low-melting point metal and extruding the mixture of the long metal fiber, polyamide-based resin and the low-melting point metal to provide a pellet. According to one embodiment, the step of adding (charging) the long-metal fiber can include the use of a glass roving device. This embodiment can include melting a mixture of the polyamide-based resin and optionally the low-melting point metal and continuously adding a roving including a long-metal fiber to the melt mixture.

Pellets obtained from the method can have a shape in which the long metal fiber is oriented in a certain direction. In exemplary embodiments, the long metal fibers may be oriented generally in the longitudinal direction of the pellets. In one embodiment, the pellet can have a length ranging from 5 to 30 mm, for example 10 to 15 mm. When the pellet has a length within these ranges, it can re-enforce the hardness and impact resistance strength of the resin composition, and there may be fewer problems in input.

The electrically insulating highly thermally conductive resin composition may be used for forming various articles, for example, a main body, a chassis, or a heat dissipating plate and the like of electro-electronic products such as TVs, computers, mobile phones, and office automating devices requiring excellent electrical insulating property and high thermal conductivity. In addition, the composition of the invention can be used in lamp sockets, lamp reflectors, electron chip sockets, connectors, and the like requiring electrical insulation/thermal conduction characteristics. According to another embodiment of the present invention, there is provided a molded product fabricated by the electrically insulating highly thermally conductive resin composition.

The following examples illustrate the present invention in more detail. However, they are exemplary embodiments of the present invention and are not limiting.

### EXAMPLES

The (A) polyamide-based resin, (B) long metal fiber, and (C) low-melting point metal used in examples and comparative examples are as follows.

(A) Polyamide-Based Resin

PPA (polyphthalic amide) having a melting point (Tm) of 300° C. and a glass transition temperature (Tg) of 125° C. is used as polyamide-based resin.

(A′) Polyphenylenesulfide resin

A polyphenylenesulfide (PPS) resin having a melting point of 280° C. is used.

(B) Long Metal Fiber

A SUS316L stainless steel roving strand including 1000 bundles having a diameter of 8 μm is used as a long metal fiber. The long metal fiber has an elastic coefficient of 197 GPa and a tensile strength of 485 MPa.

(C) Low-Melting Point Metal

A tin/aluminum solid solution with tin as the main component is used as the low-melting point metal. The tin/aluminum solid solution includes tin mixed at a weight ratio of 99.7 wt % and aluminum mixed at a weight ratio of 0.3 wt %, and the solidus temperature thereof is 228° C.

(D-1) Ceramic Inorganic Filler

Boron nitride (BN) having an average particle diameter of 45 μm is used as a ceramic inorganic filler.

(D-2) Ceramic Inorganic Filler

Aluminum nitride (AlN) having an average particle diameter of 2.5 μm is used as a ceramic inorganic filler.

### Examples 1 to 3 and Comparative Example 1

Pellets are produced using the above referenced components in the amounts shown in Table 1 to produce the compositions of Examples 1 to 3 and Comparative Example 1. The compositions are fabricated by using a glass roving device with a plurality of bundled fiber strands, and in particular by immersing long metal fibers into the resin melted in a resin bath of the glass roving device, extruding, and cold-cutting the same.

### Comparative Examples 2 and 3

Each component is mixed in the amounts shown in the following Table 1 in a mixer and extruded by using a twin screw extruder with a L/D=35, φ=45 mm at a process temperature suitable for each resin (320° C. for PPA and 300° C. for PPS), a screw rotation speed of 150 rpm, the first vent pressure of about −600 mmHg, and a speed of 60 kg/h. The extruded strand is cooled in water and cut into pellets by a rotary cutter.

TABLE 1
(units: parts by weight)

| | | | | Comparative | | |
|---|---|---|---|---|---|---|
| | Examples | | | Examples | | |
| | 1 | 2 | 3 | 1 | 2 | 3 |
| (A) polyamide-based resin | 100 | 100 | 100 | — | 100 | 100 |
| (A′) polyphenylenesulfide resin | — | — | — | 100 | — | — |
| (B) long metal fiber (SUS316L) | 29 | 41 | 52 | 52 | — | — |
| (C) low melting point metal (Sn/Al) | 2 | 2 | 2 | 2 | — | — |
| (D-1) inorganic filler (BN) | — | — | — | — | 40 | — |
| (D-2) inorganic filler (AIN) | — | — | — | — | — | 40 |

Pellets obtained from Examples 1 to 3 and Comparative Examples 1 to 3 are dried with hot air at 80° C. for about 5 hours and extruded in a 10 oz extruder to provide a specimen for determining physical properties.

The physical properties of the obtained specimens are measured in accordance with the following methods, and the results are shown in the following Table 2.

(1) Thermal Conductivity: measured in accordance with guarded heat flow method.

(2) Electrical characteristic: determined by measuring surface resistance in accordance with ASTM D257.

(3) Mechanical properties: determined by measuring flexural modulus and flexural strength in accordance with ASTM D790.

TABLE 2

| | Example | | | Comparative Example | | |
|---|---|---|---|---|---|---|
| | 1 | 2 | 3 | 1 | 2 | 3 |
| Thermal conductivity [W/mK] | 0.9 | 1.8 | 2.8 | 2.9 | 1.7 | 1.0 |
| Sheet resistance [Ω/□] | ≧10¹² | ≧10¹² | ≧10¹² | ≦10³ | ≧10¹² | ≧10¹² |
| Flexural modulus [kgf/cm²] | 142,000 | 168,000 | 189,000 | 185,000 | 115,000 | 200,000 |
| Flexural strength [kgf/cm²] | 1,600 | 2,650 | 2,700 | 2,600 | 770 | 650 |

As shown in Table 2, the specimens prepared from the compositions of Examples 1 to 3 exhibit a balance of thermal conductivity, electrically insulating property, and mechanical properties. In contrast, Comparative Example 1 in which polyphenylenesulfide is used instead of a polyamide-based resin exhibits low surface resistance, which indicates deteriorated electrical insulation properties. Comparative Examples 2 and 3, which do not include the low-melting point metal and long metal fiber, and which include ceramic fillers combined with the polymer, exhibit significantly lower flexural strength than Examples 1 to 3, and thus also have deteriorated mechanical properties.

The above results demonstrate that the polyamide-based resin/low-melting point metal/long metal fiber resin composite material can have excellent mechanical strength and hardness, excellent thermal conductivity, and simultaneously good electrically insulating characteristics.

Many modifications and other embodiments of the invention will come to mind to one skilled in the art to which this invention pertains having the benefit of the teachings presented in the foregoing descriptions. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation, the scope of the invention being defined in the claims.

What is claimed is:

1. An electrically insulating thermally conductive resin composition, comprising:
(A) 100 parts by weight of a polyamide-based resin;
(B) 10 to 80 parts by weight of a long metal fiber comprising copper, nickel, aluminum, iron, chromium, molybdenum, an alloy thereof, or a combination thereof, based on 100 parts by weight of the polyamide-based resin (A); and
(C) 0.5 to 10 parts by weight of a low-melting point metal, based on 100 parts by weight of the polyamide-based resin (A).

2. The electrically insulating thermally conductive resin composition of claim 1, comprising the long metal fiber (B) in an amount of 50 to 75 parts by weight based on 100 parts by weight of the polyamide-based resin (A).

3. The electrically insulating thermally conductive resin composition of claim 1, wherein the polyamide-based resin (A) comprises nylon 6, nylon 46, nylon 66, nylon 69, nylon 610, nylon 612, nylon 611, nylon 1212, nylon 1012, nylon 11, nylon 12, nylon 6T, nylon 61, nylon 9T, nylon 10T, nylon 11T, nylon 12T, nylon 12I, polyphthalamide (PPA), nylon 6/66, nylon 6T/6I, nylon 66/6T, poly-bis-(4-aminocyclohexyl)methanedodecamide (nylon PACM12), nylon dimethyl PACM12, polymetaxylene adipamide (MXD 6), nylon 11T(H), or a combination thereof.

4. The electrically insulating thermally conductive resin composition of claim 1, wherein the low-melting point metal (C) has a solidus temperature that is lower than the melting point of the polyamide-based resin.

5. The electrically insulating thermally conductive resin composition of claim 1, wherein the low-melting point metal (C) comprises a first metal element comprising tin, bismuth, lead, or a combination thereof, and a second metal element comprising copper, aluminum, nickel, silver, germanium, indium, zinc, or a combination thereof.

6. The electrically insulating thermally conductive resin composition of claim 1, wherein the long metal fiber (B) is a roving strand bundle comprising a plurality of metal fibers having a diameter of 1 to 65 μm.

7. A method of fabricating an electrically insulating thermally conductive resin composition comprising:
adding 10 to 80 parts by weight of a long metal fiber into a mixture comprising 100 parts by weight of a polyamide-based resin and 0.5 to 10 parts by weight of a low-melting point metal to form a composition of the polyamide-based resin, long metal fiber and low-melting point metal.

8. The method of fabricating an electrically insulating thermally conductive resin composition of claim 7, further comprising extruding the composition to form a pellet.

9. The method of fabricating an electrically insulating thermally conductive resin composition of claim 7, wherein the step of adding the long metal fiber comprises melting a mixture comprising the polyamide-based resin and the low-melting point metal, and continuously adding a roving including the long metal fiber to the melted mixture.

10. A pellet manufactured from the electrically insulating thermally conductive resin composition according to claim 1.

11. The pellet of claim 10, wherein the pellet has a length of 5 to 30 mm.

12. A molded product fabricated using the electrically insulating thermally conductive resin composition according to claim 1.
